(19) United States
(12) Patent Application Publication
(10) Pub. No.: US 2022/0145217 A1
(43) Pub. Date: May 12, 2022

(54) ANTI-FOGGING FORMULATION

(71) Applicant: FogOff LLC, Frankfort, MI (US)

(72) Inventor: Charles W. Olsen, JR., Frankfort, MI (US)

(21) Appl. No.: 17/522,427

(22) Filed: Nov. 9, 2021

Related U.S. Application Data
(60) Provisional application No. 63/112,410, filed on Nov. 11, 2020.

(51) Int. Cl. C11D 1/88; C11D 11/00; C11D 17/04; C11D 3/37; C11D 3/43; G02B 1/18

(52) U.S. Cl. CPC C11D 1/88; C11D 11/0035; C11D 11/0017; G02B 1/18; C11D 3/3788; C11D 3/43; C11D 17/049

(57) ABSTRACT

A formulation useful for preventing fogging of optical devices (e.g., eyewear, phone screens and the like) is comprised of an amphoteric fluorosurfactant, siloxane wetting agent and a solvent such as an alcohol. The formulation may be deposited upon a fabric to create an antifog wipe. The formulation is particularly useful for preventing fogging on hydrophobic and oleophobic surfaces such as hard coated plastic eyewear.

### CROSS-REFERENCE TO RELATED APPLICATION

This application claims the benefit of U.S. Provisional Application Ser. No. 63/112,410 filed on Nov. 11, 2020, the contents of which are incorporated herein in its entirety by reference.

### FIELD

The invention relates to an anti-fogging formulation for use in preventing fogging of optical devices such as eyewear, goggles and the like. In particular, the invention relates to formulations of an amphoteric fluorosurfactant and siloxane wetting agent.

### BACKGROUND

Methods for cleaning and preventing fogging on hard surfaces are known such as glass lenses, sunglass lenses, cellphone screens, watch crystals, TV screens, PC glass screens, mirrors or other products. Typically, the application of cleaners and antifogging agents are applied by microfiber woven fabrics that are pre-wetted or by applying a mist from a spray bottle using a solvent substantially comprised of water.

Previous formulations that have provided antifogging have typically used substantial amounts of water mixed with a polar solvent such as alcohols, mixtures of several surfactants and high concentrations of surfactant for each application (see for example, U.S. Pat. No. 10,611,940). The effectiveness coatings have tended to be more effective on more polar surfaces (hydrophobic) and not as effective on hydrophobic and oleophobic surfaces such as eye wear having protective coatings for the underlying lens material (e.g., polycarbonate). Likewise, the durability of the coatings has tended to be short lived requiring repeated application.

Accordingly, it would be desirable to provide an antifogging formulation that solves one or more of the problems of the prior art such as those described above. In particular, it would desirably to provide an antifogging formulation that has improved effectiveness on hard surfaces having a greater water contact angle (e.g., hard coated eye wear) and that display better durability to reduce the application frequency.

### SUMMARY

An antifogging/antistatic formulation has been discovered that prevents fogging on various substrates that have polar surfaces to non-polar surfaces that are hydrophobic or hydrophobic and oleophobic such as polycarbonate used in eyewear, inorganic glasses used in smart phones including substrates that have hard coatings to impart one or more characteristics (e.g. scratch resistance, tinting, polarization and the like). In particular, it has been discovered that when a particular fluorosurfactant is combined with a siloxane wetting agent in alcohols fogging may be prevented for long periods of time (24 hours or more) with small amounts of the fluorosurfactant. In addition, such formulations may also be useful for antistatic applications including, for example, laundry dryer sheets and the like.

A first aspect of the invention is a formulation comprised of

(i) an amphoteric fluorosurfactant represented by:

R¹—Y—Z.

where R¹ represents a fluoroalkyl or fluoroalkenyl group having 3 to 22 carbons, Y is an amide, sulfoamide, carbonyl or oxa group, and Z is a zwitterionic group,

(ii) a siloxane wetting agent represented by:

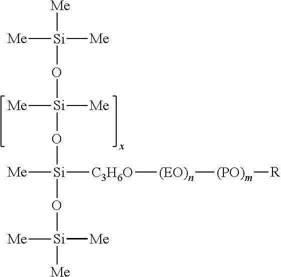

where Me is a methyl group or ethyl group, EO is an ethylene oxide group, PO is a propylene oxide group, x is 0 to 6, n and m are independently 0 to 50 so long as n+m is at least 5, and R is OH or a substituted or unsubstituted alkyl of 1 to 6 carbons and (iii) and an alcohol having at most 5% by weight of water.

A second aspect of the invention is a wipe or sheet comprised of a piece of fabric having thereon the formulation of the first aspect.

A third aspect of the invention is an optical device comprised of the first aspect disposed upon at least a portion of a substrate, the substrate being optically transparent. Likewise, the third aspect encompasses substrates wherein the alcohol has evaporated leaving the fluorosurfactant and siloxane wetting agent upon the substrate (residue), wherein the residue is essentially free of water or alcohol as described herein.

A fourth aspect of the invention is an anti-fog wipe comprised of fabric having thereon a composition comprised of

(i) an amphoteric fluorsurfactant represented by:

R¹—Y—Z.

where R¹ represents a fluoroalkyl or fluoroalkenyl group having 3 to 22 carbons, Y is an amide, sulfoamide, carbonyl or oxa group, and Z is a zwitterionic group, and

(ii) a siloxane wetting agent represented by:

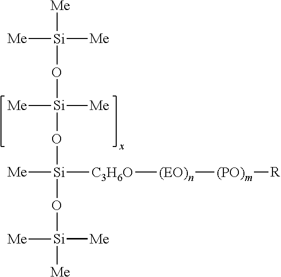

where Me is a methyl group or ethyl group, EO is an ethylene oxide group, PO is a propylene oxide group, x is 0 to 6, n and m are independently 0 to 50 so long as n+m is at least 5, and R is OH or a substituted or unsubstituted alkyl of 1 to 6 carbons.

### DETAILED DESCRIPTION

The explanations and illustrations presented herein are intended to acquaint others skilled in the art with the invention, its principles, and its practical application. The specific embodiments of the present disclosure as set forth are not intended to be exhaustive or limit the scope of the disclosure.

The formulation is comprised of an amphoteric fluorosurfactant represented by:

R¹—Y—Z.

where R¹ represents a fluoroalkyl or fluoroalkenyl group, Y is an amide, sulfoamide, carbonyl or oxa group, and Z is a zwitterionic group. Desirably, R¹ is a fluoroalkyl. R1 may be any chain length that realizes the desired antifogging on a substrate. Typically it is desired for the fluorosurfactant at ambient conditions (˜20 to 25° C.) to have a paste like consistency in that it does not flow to fill a volume in the absence of a mechanical external force and retains it shape when plastically deformed by an external force (i.e., the material has a yield point greater than the force of gravity and displays shear thinning behavior). Generally, R¹ has from 3 to 28, 22, 18, 12, 8, 6 or 4 carbons. The amount of fluorine atoms in R¹ may be any useful amount from partial substitution to complete substitution of the hydrogen atoms (e.g., perfluoroalkyl or perfluoroakenyl). When partially substituted, typically at least 10%, 20%, 50% to 95%, 90% or 80% by mole of the hydrogen atoms have been substituted with fluorine. R¹ may be branched or linear but desirably is linear.

Y is a linking group between R¹ and Z, the zwitterion, and is an amide, sulfoamide, carbonyl or oxa group. Typically, Y is an amide.

The zwitterion Z may be any zwitterion such as those known in the art. Exemplary zwitterions include betaine, sulfobetaine, amino oxides, or betaines where the carboxylate group has been substituted with a phosphate group (e.g., phosphatidylcholines or psilocybin). Typically, Z is a betaine. A suitable fluorosurfactant is available from Chemours under the tradename CAPSTONE FS-50. Other examples may include THETAWET FS-8400 and CHEMGUARD S-500, but these may be less desirable due to the presence of low volatility solvents believed to be glycols, which may need to be removed to realize the surprisingly good anti-fogging behavior.

The formulation is also comprised of (ii) a siloxane wetting agent represented by:

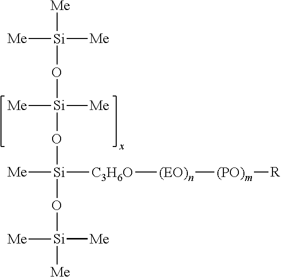

where Me is a methyl or ethyl group, but is preferably methyl, EO is ethylene oxide group, PO is a propylene oxide, x is 0 to 6, n and m are independently 0 to 50 so long as n+m is at least 5, 7 or 10 to any suitable amount such as 100 or 50, and R is OH or is OH or a substituted or unsubstituted alkyl of 1 to 6 carbons. For example, the alkyl may be substituted with any heteroatom (e.g., oxygen) including for example a terminal alcohol or acetoxy. R may be, for example, a methyl group or acetoxy group. In an embodiment x is at most 3 and desirably 0. In another embodiment, the Hydrophobe-Lipophobe Balance (HLB) is from 10 to 14. Examples of suitable wetting agents are available from Evonik under the tradename TEGO WET KL 245, from Momentive under the tradename SILWET L-77, and The Dow Chemical Company under the tradename DOWSIL 67, 500W, 501W, Q2-5211or 502W.

The formulation is comprised of a solvent typically having at most 5% by weight of water. It is understood that the entire formulation has at most about 5% by weight of water regardless if it is present in the solvent or the other components of the formulation. For example, the fluorosurfactant may be commercially available as a solution in an alcohol. The solvent generally is a polar solvent such as a polar protic solvent (e.g., an alcohol). Illustratively, the alcohol may be a single alcohol or mixture of alcohols so long as the alcohols dissolve the fluorosurfactant and siloxane wetting agent at the concentrations desired. Typically, the alcohol is comprised of one or more of methanol, ethanol, propanol, or isopropanol. In an embodiment, the alcohol is ethanol and in particular a denatured ethanol such specially denatured alcohol (SDA) as specified by U.S. Title 27 of the Code of Federal Regulations Section 21.151. In a particular embodiment, the alcohol is denatured with tert butyl alcohol bittered with denatonium benzoate. In an embodiment, the amount of water in the alcohol or formulation is at most about 1%, 0.1% or even 0.01% by weight.

The concentration of each component typically is as follows. The amphoteric fluorosurfactant may be present in an amount of 0.1%, 0.5%, or 1% to 25%, 20%, 15%, 10% or 5% by weight of the formulation and the siloxane wetting agent is present in an amount of 0.05%, 0.1% to 5%, 4%, 3% or 2% by weight of the formulation with the balance of the formulation being the solvent (e.g., alcohol, which may include some amount of water). Typically, the ratio by weight of the fluorosurfactant/siloxane wetting agent is 0.1/1, 0.5/1, 1/1, 2/1 or 5/1 to 20/1 or 15/1.

In an embodiment, a small amount of a weak acid (e.g., pKa of about 2 to 6) such as a carboxylic acid (desirably a low molecular weight carboxylic acid such as one having less than 12, 8 or 6 carbons) may be added to ensure that environmental contaminates do not deleteriously impact the performance of the antifog formulation application to a fabric or substrate. Typically, the amount of carboxylic acid when used is on the order of 0.001 to 0.1 percent by weight of the composition. In an embodiment, the carboxylic acid is acetic acid. In an embodiment, the carboxylic acid may be sufficiently volatile so that it evaporates from a substrate upon application to a substrate.

The formulation may contain other additives useful in antifogging compositions such as those known in the art. For example, additives such as chelating agents, builder, preservative, colorant, fragrance, stabilizing agents (e.g., UV), rheological agents, antibacterial agents and the like may be used so long as the antifogging is not substantially reduced.

The formulation may be used on any substrate which is desired to have reduced fogging or antistatic behavior on at least a portion of the surface. Typically, the substrate is any useful for transmitting or reflecting light and may be an optically transparent or reflective substrate (e.g., mirror). It is understood that optically transparent is to be read broadly and need not be for visible light, but may be optical devices for other spectra of electromagnetic radiation (e.g., UV and infrared). Generally, the substrate is any visible light optically transparent substrate such as any of those known in the art and may include, organic polymers (e.g., coated or uncoated polycarbonate), inorganic glasses (e.g., silicate, aluminate, alumino-silicate, alkali alumino silicates and the like) and transparent inorganic salts such as those that may be used in laser optics and the like. Examples of such optical devices include eyewear, goggles, windows, face shields, optical screens, watch crystals, for devices such as computers, phones, and televisions.

The formulation may be disposed upon any substrate desired by any suitable method such as those known in the art. For example, the formulation may be sprayed from a spray bottle and wiped with a non-abrasive cloth such as microfiber cloth. In an embodiment, the formulation is disposed upon a piece of any suitable fabric which is wiped on the substrate depositing the formulation on the substrate, wherein the solvent evaporates and the remaining surfactant and wetting agent (formulation) form an antifogging film. In another embodiment, the solvent is allowed to evaporate from the fabric and then the formulation is disposed upon the substrate by wiping the fabric only having the formulation disposed thereon, where wiping may include, for example, tumbling in a dryer with other fabrics.

In a particular embodiment that realizes good deposition without need to apply excessive formulation to the wipe to realize a desired uniform, durable film on a substrate, the wipe desirably is a nonwoven fabric that is formed of microfibers that are hydrophobic, but may be any material that is useful to deposit the formulation thereon that can be used to wipe a substrate to transfer the formulation to said substrate. Microfiber, herein, means fibers having an average diameter not greater than about 100 microns, for example, having a diameter of from about 0.2 microns to about 30 microns. More specifically, microfiber may also have an average diameter of from about 1 micron to about 20 microns. The wipe or fabric as well, desirably, has a fabric weight of about 0.5 oz/sq. yd to 2.5 oz/sq. yd. Examples of useful fabric materials include polyolefin (polypropylene, copolymers of propylene and ethylene and polyethylene) as well as paper, rayon, acrylic, cotton, nylon, polyethylene terephthalate, or polybutylene terephthalate. Desirably, the fabric is hydrophobic (i.e., wetting by water of the underlying material has a contact angle at least 90°, 100°, 110° or even 120°), such polyolefins including polypropylene, copolymers of propylene and ethylene and polyethylene.

Depending on the application desired, the anti-fog wipe may have differing suitable surface areas. For example, if the application is a one-time wipe enclosed in a sealed packet, the surface area of the fabric is desirably an amount that allows for the effective transfer of the formulation onto the substrate being treated while minimizing the amount of formulation on the fabric. Typically, the surface area of the fabric for single use applications is from 0.1, 0.5, or 1 to 20, 15 or 10 m²/g of fabric. Alternatively, the wipe may be reusable and may be contained in a resealable container. In this case, it may be advantageous to have greater fabric surface area such as 1 to 10 m²/g so that greater loading of the formulation is possible, while still effectively allowing transfer to the substrate.

Once the formulation is disposed upon the fabric it may be sealed in any useful container to minimize or eliminate the evaporation of the solvent prior to use. The pouch may be any suitable containers such as those known in the art including, for example, sealed pouches of metalized plastics which may be torn open and the fabric wipe used to treat a substrate. In another embodiment, a plurality of wipes may be contained in a sealed jar, which may be accessed via lid and withdrawn individually as needed.

In a particular embodiment, the formulation has surprisingly good (in the absence of any other surfactants such as anion or cationic surfactants) fogging prevention on hydrophobic surfaces and even on hydrophobic/oleophobic surfaces such as those displaying a contact angle with water or heptane of at least 90°, 100°, 110° or even 120° as displayed by some coated eyewear lenses.

In an embodiment the antifog wipe may be essentially free of alcohol or other solvent such as water. Without being limited by theory, it is believed that because the siloxane wetting agent and fluorosurfactant are co-dissolved in a solvent such as water or alcohol, they form an intimate blend such that a wipe essentially free of the alcohol or water (less than about 1%, 0.5% or 0.1% by weight of the fluorosurfactant, siloxane wetting agent, weak acid and any other additives) exhibits good transfer to a substrate during wiping. In this case, water or a combination of water and alcohol may be used to deposit the formulation on the fabric as described above (i.e., some or all of the alcohol may be displaced). Illustratively, it may be desirable to use water to deposit onto fabric as it is being made in a like manner as sizing is applied during fabric manufacture. The water or solvent may then be removed by any suitable method such as static or flowing air drying with or without application of heat and/or reduced pressure. The resulting fabric will have the amphoteric fluorosurfactant and siloxane wetting agent disposed on it which can then be transferred to the intended surface. The amount, weight %, of the surfactant and wetting agent disposed on the fabric may vary over a wide range depending, for example, on the particular fabric used and enough to realize sufficient transfer, but typically is from about 1%, 10%, 20%, 30% or to 90%, 80% or 50% by weight of the fabric and the formulation.

Without being limiting in any way, the amphoteric fluorosurfactant and siloxane wetting agent are believed to be disposed on the fabric as an intimate mixture (i.e., without phase separation), which may be a layer structure where the hydrophilic groups of the surfactant and wetting agent align and the hydrophobic groups also align. This is believed to allow the surfactant to form the desirable anti-fogging film even in the absence of use of a solvent as for the single use wipes as described above and are particularly useful for antistatic wipes or sheets.

### Illustrative Embodiments

Embodiment 1. A formulation comprised of

(i) an amphoteric fluorosurfactant represented by:

R¹—Y—Z.

where R¹ represents a fluoroalkyl or fluoroalkenyl group having 3 to 22 carbons, Y is an amide, sulfoamide, carbonyl or oxa group, and Z is a zwitterionic group,
(ii) a siloxane wetting agent represented by:

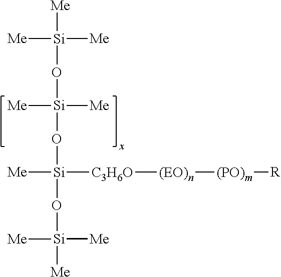

where Me is a methyl group or ethyl group, EO is an ethylene oxide group, PO is a propylene oxide group, x is 0 to 6, n and m are independently 0 to 50 so long as n+m is at least 5, and R is OH or a substituted or unsubstituted alkyl of 1 to 6 carbons and (iii) and a solvent such as alcohol having at most 5% by weight of water.

Embodiment 2. The formulation of Embodiment 1, wherein x is 0.

Embodiment 3. The formulation of Embodiment 2 or 3, wherein Y is an amide group.

Embodiment 4. The formulation of any one of the preceding Embodiments, wherein R1 is fluoroalkyl.

Embodiment 5. The formulation of Embodiment 4, wherein the fluoralkyl is perfluoryl.

Embodiment 6. The formulation of any one of the previous Embodiments, wherein the alcohol is a comprised of one or more of methanol, ethanol, propanol, or isopropanol.

Embodiment 7. The formulation of any of the preceding Embodiments wherein the alcohol is ethanol.

Embodiment 8. The formulation of any one of the preceding Embodiments, wherein the alcohol has at most about 1% by weight of water.

Embodiment 9. The formulation of any one of the preceding Embodiments, wherein the alcohol has at most about 1000 ppm of water by weight.

Embodiment 10. The formulation of any one of the preceding Embodiments, wherein the alcohol is denatured alcohol.

Embodiment 11. The formulation of Embodiment 10 wherein the denatured alcohol is specially denatured alcohol (SDA) as specified by U.S. Title 27 of the Code of Federal Regulations Section 21.151.

Embodiment 12. The formulation of Embodiment 11, wherein the denatured alcohol is denatured with tert butyl alcohol bittered with denatonium benzoate.

Embodiment 13. A wipe or sheet comprised of a piece of fabric having thereon the formulation of any one of the preceding Embodiments.

Embodiment 14. The wipe of Embodiment 13, wherein the fabric is hydrophobic.

Embodiment 15. The wipe of either Embodiment 13 or 14, wherein the piece of fabric has a surface area of about 0.1 m2/g to about 10 m2/g.

Embodiment 16. The wipe of any one of Embodiments 13 to 15, wherein the fabric is a nonwoven.

Embodiment 17. The wipe of any one of the preceding Embodiments 13 to 16, wherein the fabric is polypropylene or polyethylene.

Embodiment 18. The wipe of Embodiments 13 to 17, wherein the fabric has a diameter of about 0.5 to about 100 micrometers and a fabric weight of about 0.7 oz/sq. yd to 1.5 oz/sq. yd.

Embodiment 19. The wipe of Embodiment 18, wherein the formulation is present on the fabric in an amount from about 1% to about 90% by weight of the fabric and formulation.

Embodiment 20. The wipe of Embodiment 19, wherein the amphoteric fluorosurfactant and siloxane wetting agent together are present on the fabric in an amount from about 2% to about 80% by weight of the fabric and the fluorosurfactant and siloxane wetting agent.

Embodiment 21. The formulation of any one of Embodiments 1 to 12, wherein the amphoteric fluorosurfactant is present in an amount of 1% to 25% by weight of the formulation and the siloxane wetting agent is present in an amount of 0.1% to 5% by weight of the formulation with the balance of the formulation being the solvent (e.g., alcohol).

Embodiment 22. The formulation of Embodiment 21, further comprising a carboxylic acid in amount of 0.001% to 0.1% by weight of the formulation.

Embodiment 23. The wipe of any one of Embodiments 13 to 20, wherein the amphoteric fluorosurfactant is present in an amount of 1% to 25% by weight of the formulation and the siloxane wetting agent is present in an amount of 0.1% to 5% by weight of the formulation with the balance of the formulation being the solvent.

Embodiment 24. The wipe of Embodiment 23 further comprising a carboxylic acid in amount of 0.001% to 0.1% by weight of the formulation.

Embodiment 25. The formulation of Embodiment 22, wherein the carboxylic acid is acetic acid.

Embodiment 26. The wipe of Embodiment 24, wherein the carboxylic acid is acetic acid.

Embodiment 27. An optical device comprised of the formulation of any one of Embodiments 1 to 12, 21, 22 or 25 disposed on at least a portion of a substrate, wherein the substrate is optically transparent.

Embodiment 28. The substrate of Embodiment 27, wherein the substrate is an organic polymer, inorganic glass, or salt.

Embodiment 29. A wipe comprised of fabric having thereon a composition comprised of

(i) an amphoteric fluorsurfactant represented by:

R¹—Y—Z.

where R¹ represents a fluoroalkyl or fluoralkenyl group having 3 to 22 carbons, Y is an amide, sulfoamide, carbonyl or oxa group, and Z is a zwitterionic group, and
(ii) a siloxane wetting agent represented by:

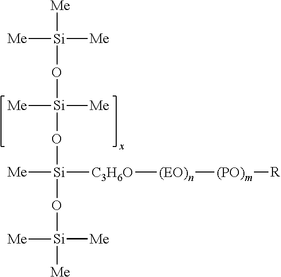

where Me is a methyl group or ethyl group, EO is an ethylene oxide group, PO is a propylene oxide group, x is 0 to 6, n and m are independently 0 to 50 so long as n+m is at least 5, and R is OH or a substituted or unsubstituted alkyl of 1 to 6 carbons. Embodiment 30. The optical device of either Embodiment 27 or 28, wherein the solvent has evaporated.

Embodiment 31. A device comprised of a substrate having thereon a composition comprised of

(i) an amphoteric fluorsurfactant represented by:

R¹—Y—Z.

where R¹ represents a fluoroalkyl or fluoralkenyl group having 3 to 22 carbons, Y is an amide, sulfoamide, carbonyl or oxa group, and Z is a zwitterionic group, and
(ii) a siloxane wetting agent represented by:

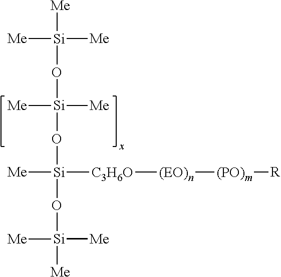

where Me is a methyl group or ethyl group, EO is an ethylene oxide group, PO is a propylene oxide group, x is 0 to 6, n and m are independently 0 to 50 so long as n+m is at least 5, and R is OH or a substituted or unsubstituted alkyl of 1 to 6 carbons. Embodiment 32. The device of Embodiment 31, wherein the composition is essentially free of water or alcohol.

Embodiment 33. The device of either Embodiment 31 or 32, wherein the composition further comprises a weak acid.

What is claimed is:

1. A formulation comprised of:
(i) an amphoteric fluorosurfactant represented by:
R¹—Y—Z.
where R¹ represents a fluoroalkyl or fluoroalkenyl group having 3 to 22 carbons, Y is an amide, sulfoamide, carbonyl or oxa group, and Z is a zwitterionic group,
(ii) a siloxane wetting agent represented by: 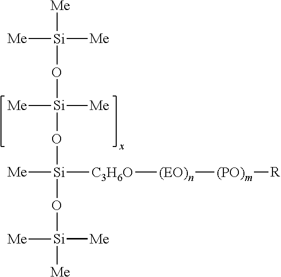
where Me is a methyl group or ethyl group, EO is an ethylene oxide group, PO is a propylene oxide group, x is 0 to 6, n and m are independently 0 to 50 so long as n+m is at least 5, and R is OH or a substituted or unsubstituted alkyl of 1 to 6 carbons and (iii) and a solvent.

2. The formulation of claim 1, wherein x is 0, Y is an amide group and R1 is a fluoroalkyl.

3. The formulation of claim 1, wherein the solvent is an alcohol comprised of one or more of methanol, ethanol, propanol, or isopropanol.

4. The formulation of claim 3, wherein the alcohol has at most about 1% by weight of water.

5. The formulation of claim 3 wherein the denatured alcohol is specially denatured alcohol (SDA) as specified by U.S. Title 27 of the Code of Federal Regulations Section 21.151.

6. A wipe or sheet comprised of a piece of fabric having thereon the formulation of claim 1.

7. The wipe or sheet of claim 6, wherein the fabric is hydrophobic.

8. The wipe or sheet of claim 6, wherein the solvent has evaporated.

9. The wipe or sheet of claim 8, wherein the formulation is present on the fabric in an amount from about 0.1% to about 10% by weight of the fabric and formulation.

10. The formulation of claim 1, wherein the amphoteric fluorosurfactant is present in an amount of 1% to 25% by weight of the formulation and the siloxane wetting agent is present in an amount of 0.1% to 5% by weight of the formulation with the balance of the formulation being the alcohol.

11. The formulation of claim 10, further comprising a carboxylic acid in amount of 0.001% to 0.1% by weight of the formulation.

12. The wipe or sheet of claim 9, wherein the amphoteric fluorosurfactant is present in an amount of 1% to 25% by weight of the formulation and the siloxane wetting agent is present in an amount of 0.1% to 5% by weight of the formulation with the balance of the formulation being the alcohol.

13. The formulation of claim 11, wherein the carboxylic acid is acetic acid.

14. An optical device comprised of the formulation of claim 1 disposed on at least a portion of a substrate, wherein the substrate is optically transparent.

15. The substrate of claim 14, wherein the substrate is an organic polymer, inorganic glass, or salt.

16. A wipe or sheet comprised of fabric having thereon a composition comprised of
(i) an amphoteric fluorosurfactant represented by:
R¹—Y—Z.
where R¹ represents a fluoroalkyl or fluoroalkenyl group having 3 to 22 carbons, Y is an amide, sulfoamide, carbonyl or oxa group, and Z is a zwitterionic group, and
(ii) a siloxane wetting agent represented by: 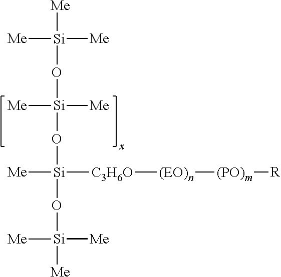
where Me is a methyl group or ethyl group, EO is an ethylene oxide group, PO is a propylene oxide group, x is 0 to 6, n and m are independently 0 to 50 so long as n+m is at least 5, and R is OH or a substituted or unsubstituted alkyl of 1 to 6 carbons.

17. The wipe or sheet of claim 16, wherein the wipe or sheet is essentially free of water or solvent.

18. An article comprised of a substrate having thereon a composition comprised of
(i) an amphoteric fluorosurfactant represented by:
R¹—Y—Z.
where R¹ represents a fluoroalkyl or fluoroalkenyl group having 3 to 22 carbons, Y is an amide, sulfoamide, carbonyl or oxa group, and Z is a zwitterionic group, and
(ii) a siloxane wetting agent represented by: 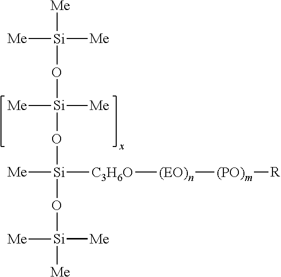
where Me is a methyl group or ethyl group, EO is an ethylene oxide group, PO is a propylene oxide group, x is 0 to 6, n and m are independently 0 to 50 so long as n+m is at least 5, and R is OH or a substituted or unsubstituted alkyl of 1 to 6 carbons.

19. The article of claim 18, wherein the composition is essentially free of water or alcohol.

20. The article of claim 18, wherein the composition further comprises a weak acid.
